(19) United States
(12) Patent Application Publication
(10) Pub. No.: US 2012/0219144 A1
(43) Pub. Date: Aug. 30, 2012

(54) VIRTUALIZING HUMAN AGENTS ACROSS MULTIPLE LOCATIONS

(75) Inventors: Arup Acharya, Nanuet, NY (US); Nilanjan Banerjee, West Bengal (IN); Suresh N. Chari, Scarsdale, NY (US); Shachi Sharma, Delhi (IN)

(73) Assignee: INTERNATIONAL BUSINESS MACHINES CORPORATION, Armonk, NY (US)

(21) Appl. No.: 13/034,966

(22) Filed: Feb. 25, 2011

(51) Int. Cl. H04M 3/00

(52) U.S. Cl. 379/265.11

(57) ABSTRACT

Methods and arrangements for virtualizing human agents across multiple locations. A first agent is associated with a first contact center and a second agent is associated with a second contact center. An availability status of the second agent is published, both to the first contact center and to the second contact center. An incoming communication is accepted at the first contact center and a free status of the second agent is ascertained. The incoming communication is routed from the first contact center to the second agent.

### BACKGROUND

Typically, a telephone contact center, or call center, employs several agents who receive phone calls, or could even be at the receiving end of a web-chat or other method of communication, by way of offering and providing customer service. Each agent is normally associated with one and only one contact center and is available to assist only in that location, or only in association with a particular group of agents belonging to a given company or section thereof. Conventionally, there is very little flexibility in such a scenario that would make it easier for an agent to conduct work that is not associated with simply one predetermined location or setting.

### BRIEF SUMMARY

In summary, one aspect of the invention provides a method comprising: associating a first agent with a first contact center; associating a second agent with a second contact center; publishing availability status of the second agent; the publishing comprising publishing an availability status of the second agent both to the first contact center and to the second contact center; accepting an incoming communication at the first contact center; ascertaining a free status of the second agent; and routing the incoming communication from the first contact center to the second agent.

Another aspect of the invention provides an apparatus comprising: at least one processor; and a computer readable storage medium having computer readable program code embodied therewith and executable by the at least one processor, the computer readable program code comprising: computer readable program code configured to associate a first agent with a first contact center; computer readable program code configured to associate a second agent with a second contact center; computer readable program code configured to publish availability status of the second agent both to the first contact center and to the second contact center; computer readable program code configured to accept an incoming communication at the first contact center; computer readable program code configured to ascertain a free status of the second agent; and computer readable program code configured to route the incoming communication from the first contact center to the second agent.

An additional aspect of the invention provides a computer program product comprising: a computer readable storage medium having computer readable program code embodied therewith, the computer readable program code comprising: computer readable program code configured to associate a first agent with a first contact center; computer readable program code configured to associate a second agent with a second contact center; computer readable program code configured to publish availability status of the second agent both to the first contact center and to the second contact center; computer readable program code configured to accept an incoming communication at the first contact center; computer readable program code configured to ascertain a free status of the second agent; and computer readable program code configured to route the incoming communication from the first contact center to the second agent.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 schematically illustrates an arrangement of two contact centers with presence servers and the handling of an incoming call or web-chat.

FIG. 3 schematically illustrates a contact center agent and elements employed thereby.

FIG. 4 sets forth a process more generally for virtualizing human agents across multiple locations.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

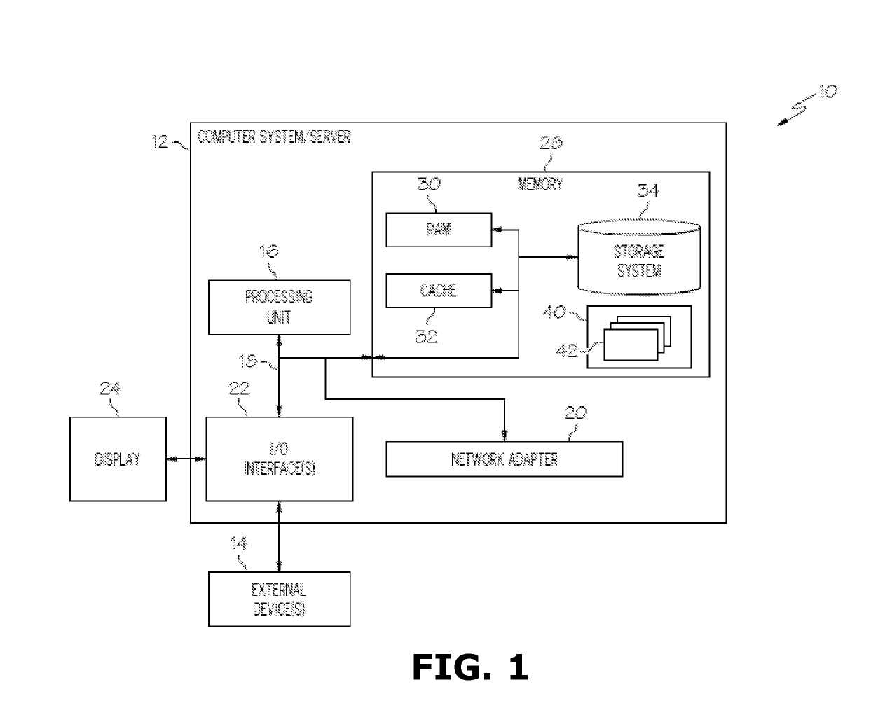

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In accordance with embodiments of the invention, computing node 10 may not necessarily even be part of a cloud network but instead could be part of another type of distributed or other network, or could represent a stand-alone node. For the purposes of discussion and illustration, however, node 10 is variously referred to herein as a “cloud computing node”.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

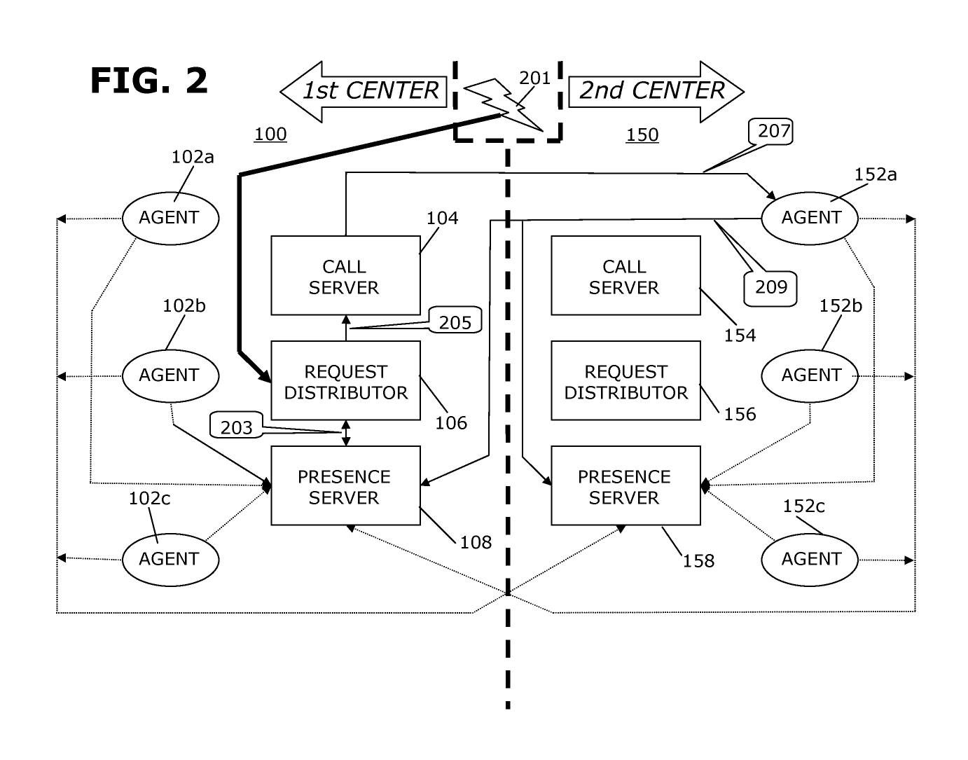

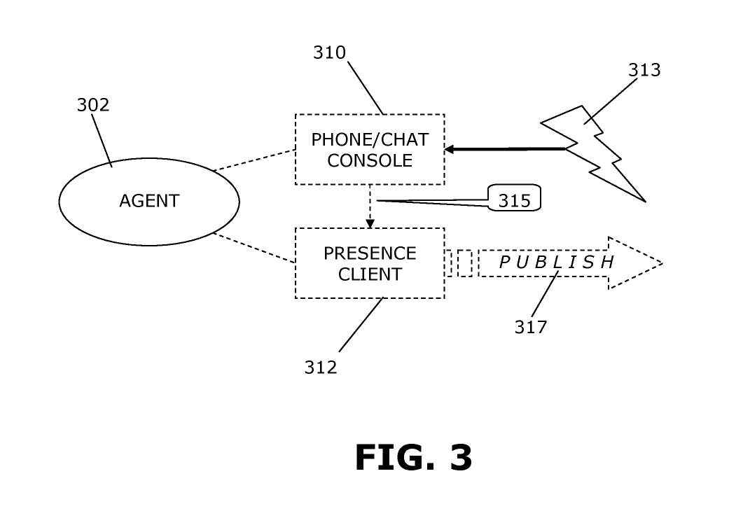

The disclosure now turns to FIGS. 2 and 3. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12 in FIG. 1. In accordance with an example embodiment, most if not all of the process steps, components and outputs discussed with respect to FIGS. 2 and 3 can be performed or utilized by way of a processing unit or units and system memory such as those indicated, respectively, at 16 and 28 in FIG. 1, whether on a server computer, a client computer, a node computer in a distributed network, or any combination thereof.

Broadly contemplated herein, in accordance with at least one embodiment of the invention, are provisions that permit a human agent to be active simultaneously across multiple contact centers, such that when an agent is free, a request to any of the contact centers can be routed to that agent.

In accordance with at least one embodiment of the invention, when an agent is busy handling a customer session for a particular contact center, he/she appears busy across all contact centers in play. This is in contrast to conventional circuit-switched telephony systems, where each contact center is controlled through one (logical) telephony switch and the switch essentially preordains or predetermines which agent or agents are free to take an incoming call. If an agent is part of an ongoing call, then the switch considers the agent to be busy and if there is no call currently handled by the agent, then the agent is considered free. In such a setting, if an agent were to be shared across multiple contact centers, the agent would need to be connected to all of the switches but, more importantly, since each switch operates independently of others, there would be no higher-level or coordinated view of when an agent is free or busy with respect to the totality of switches and contact centers.

With contact centers that conventionally offer web-chats, a problem still exists in that a single request distributor handles pending requests for web-chats and distributes it across available agents. With web-chat, it is possible for an agent to be handling multiple web-chat requests simultaneously but all the requests are part of the same contact center, i.e. there is no way for an agent to simultaneously be engaged in web-chat requests from multiple contact centers.

In accordance with at least one embodiment of the invention, a capability is employed to permit an agent to communicate across several contact centers as to whether he/she is busy or free. By way of an illustrative and non-restrictive example, such a capability can be leveraged by the presence capability of “unified communications” currently being deployed widely. (For background purposes, a discussion of “unified communications” and its relation to presence, as may be applied in accordance with at least one embodiment of the invention, may be found in Acharya et al., infra.) Further, there is broadly contemplated herein the routing of requests within a given contact center based on the presence status advertised by agents themselves. In this manner, if an agent is handling a request for a given contact center, all other contact centers in play will consider that agent to be unavailable for handling new requests.

In accordance with at least one embodiment of the invention, a contact center includes a presence server, while a presence client is associated with each agent in the contact center. Each agent further has a softphone and/or web-chat console that permits the agent to engage in customer interaction, and at the same time the agent is associated with at least one other contact center. This softphone/web-chat console is capable of receiving a call and/or web-chat request from any of the contact centers that the agent is associated with. When a call is received by this softphone (or a chat request comes in to the web-chat agent), the presence client publishes a “busy” status, on behalf of the agent, to each of the contact centers. Particularly, the Presence client of the agent transmits a message to the presence server of the contact center where the agent is situated and also to the presence server of each corresponding contact center with which the agent is associated. At the presence server of each contact center, when a “busy” status is received, the presence server records/maintains the corresponding state of the agent as “busy”. Similarly, when the agent finishes handling a call or web-request, the presence client publishes a “free” status update to the presence server of each contact center with which the agent is associated.

In accordance with at least one embodiment of the invention, in order to incorporate the above notion of what may be termed “agent-advertised” presence, a request distribution entity (e.g., phone-switch, SIP [Session Initiation Protocol] session control, web-chat request distributor) queries the presence server for a list of available agents. Based on that information, it selects an agent from the pool of free agents and serves to route the call.

While the use of presence servers is discussed herein by way of affording a capability of monitoring the availability of agents among contact centers, among other tasks, it should be understood that they are presented herein merely by way of illustrative and non-restrictive example, and that any suitable analogously functioning element can be employed as an alternative. To better understand the use of a presence capability in the context of embodiments of the invention, a brief description follows by way of background.

Generally, while initially developed as a means for communicating the “online status” in instant messaging applications, presence has become a key enabler of web-based content provider converged applications (for example, GOOGLE TALK® and SKYPE® applications), enterprise converged applications (for example, SAMETIME® application) and service provider/telephone company converged applications (for example, Push-to-talk applications). GOOGLE TALK is a registered trademark of Google Inc. in the United States and other countries. SKYPE is a registered trademark of Skype Limited Corp. in the United States and other countries. SAMETIME is a registered trademark of International Business Machines Corp. in the United States and other countries.

Presence, broadly defined as an event publish-notification infrastructure for converged applications, has emerged as a key mechanism for collecting and disseminating context attributes for next-generation services in both enterprise and provider domains. Presence can be viewed as the ability of a communications infrastructure to both track and disseminate a variety of dynamic attributes of individuals, objects and/or devices. Common examples of presence information include but are not limited to a status update on a social network (as for example “user A is away”) and/or a location update for an object (as for example “taxi 123” is now located in “geographic area A”). Given the large amount of presence information available and its apparent usefulness in a variety of contexts, obtaining, organizing and disseminating presence information in useful ways is highly desirable.

Additional information on presence systems can be found elsewhere, for example in co-pending and commonly assigned U.S. application Ser. No. 12/792,360, entitled “Standard Integrated Service Assurance Using Virtualized Federated Presence Infrastructure”, filed on Jun. 2, 2010, in co-pending and commonly assigned U.S. application Ser. No. 12/976,488, entitled “Systems and Methods for Creating Scalable Presence Subscriptions in Federated Presence Environments filed on Dec. 22, 2010, and in Acharya et al., Programmable Presence Virtualization for Next-Generation Context-Based Applications, IEEE International Conference on Pervasive Computing and Communications, 2009, 9-13 Mar., page 1-10. All three of the above-cited references are hereby fully incorporated by reference herein as if set forth in their entirety herein.

FIG. 2 schematically illustrates an arrangement of two contact centers with presence servers and the handling of an incoming call, in accordance with at least one embodiment of the invention. It should be understood that in referring to call centers and telephone calls herebelow, reference can also be assumed to be made to web chats that arrive at contact centers and are handled by agents. Further, to the extent that two contact centers (100 and 150) are discussed herebelow, it should be understood and appreciated that embodiments of the invention can readily be employed in the context of three or more contact centers.

As shown, in accordance with at least one embodiment of the invention, and for the purposes of discussion by way of an illustrative and non-restrictive example, a first contact center 100 has associated therewith, e.g., located on-site, three agents 102a/b/c. Contact center 100 further includes a call server 104, request distributor 106 and presence server 108, the functions of which will be better understood from discussion herebelow. Likewise, a second contact center 150 has associated therewith, e.g., located on-site, three agents 152a/b/c. Contact center 150 further includes a call server 154, request distributor 156 and presence server 158, the functions of which will be better understood from discussion herebelow.

In accordance with at least one embodiment of the invention, and as will be better understood herebelow, agents 102a/b/c of contact center 100 are further associated with contact center 150, while agents 152a/b/c of contact center 150 are further associated with contact center 100. Practically speaking, this means that agents of one contact center are able to take incoming calls (or web-chats) not only at their “home” contact center but also from at least one other contact center.

In accordance with at least one embodiment of the invention, as shown with the dotted arrows, agents 102a/b/c each have a capability to publish their status, e.g., “busy” or “free”, not only to their “home” presence server 108 but also to the presence server 158 of contact center 150. Likewise, agents 152a/b/c each have a capability to publish their status not only to their “home” presence server 158 but also to the presence server 108 of contact center 100. It should be understood that, for illustrative purposes only, agents 102a/b/c and 152a/b/c are shown as all being associated with both contact centers 100/150 and thus in communication with both presence servers 108/158. In practice, any given agent may be associated with any one, two or more contact centers as deemed suitable, wherein each agent in a contact center need not necessarily be associated with the exact same contact centers as any or all other agents.

The discussion now turns to a description of the handling of an incoming call or web-chat at one contact center and its routing to another, in accordance with at least one embodiment of the invention. The solid arrows in FIG. 2 indicate such actions.

As shown, in accordance with at least one embodiment of an invention, an incoming call or web-chat 201 goes to the first contact center 100 at the specific choice of the individual initiating the call or web-chat 201. It is thus directed to request distributor 106. As shown, request distributor 106 then queries (203) presence server 108 for available agents, or agents with a status (e.g., “free”) indicative of being able to handle the incoming call or web-chat 201. In the illustrated example, agents 102a/b/c and 152a/b/c from both contact centers 100/150 have published a status to presence server 108.

In accordance with at least one embodiment of the invention, information on available agents is returned to request distributor 106, which chooses an agent for handling the call/web-chat 201. In the present example, agent 152a, having already published his/her status as “free” to presence server 108, is chosen. Accordingly, request distributor 106 prompts (205) call server 104 to route (207) the call/web-chat from the first contact center 100 to agent 152a.

In accordance with at least one embodiment of the invention, upon receipt of the call/web-chat, agent 152a publishes an updated status (209) to both of the presence servers 108/158. Accordingly, for as long as the agent 152a is engaged in the call or web-chat, the presence servers 108/158 will contain a status of agent 152a as unavailable (e.g., “busy”), thereby obviating any possibility of agent 152a receiving another incoming call/web-chat during such time. Updates of status from “free” to “busy”, or vice-versa, can be undertaken automatically in a manner to be better appreciated herebelow.

FIG. 3 schematically illustrates a call center agent and elements employed thereby, in accordance with at least one embodiment of the invention.

In accordance with at least one embodiment of the invention, an agent 302 has (e.g., has at his/her disposal), a phone and/or chat console 310 and a presence client 312. Phone/chat console 310 and presence client 312 are linked such that upon receipt of an incoming call or web-chat 313, presence client 315 receives an alert from phone/chat console 310 to the effect. Generally, presence client 312 is configured for communicating with presence servers in contact centers, including the “home” contact center with which agent 302 is directly associated. Thus, presence client 312 is configured to publish (315) the status of agent 302 (e.g., “busy”, “free”) to presence servers.

In accordance with at least one embodiment of the invention, once presence client 312 is alerted of the incoming call/web-chat 313, it automatically publishes (315) a “busy” status to presence servers. Thence, once the call/web-chat 313 is terminated, phone/chat console 310 alerts presence client 312 to that effect and the latter automatically publishes (315) a “free” status to presence servers.

While publishing (315) takes place, in accordance with at least one embodiment of the invention, at times of the arrival or termination of a phone call or web-chat 313, publishing can also take place on a predetermined period basis. Thus, even if significant time has elapsed since the arrival and/or termination of a phone call or web-chat 313, presence client 312 can publish (315) a respective status of agent 302 at predetermined intervals, such as once every 10 minutes or once every 20 minutes.

In accordance with an example embodiment of the invention, multiple-SIP URI's (Uniform Resource Identifiers) are allocated to agent 302, with one URI being allocated for each contact center with which agent 302 is in communication. Presence client 312 is then multi-headed, wherein presence client 312 has a capability to publish presence information to more than one presence server simultaneously using separate SIP URI's.

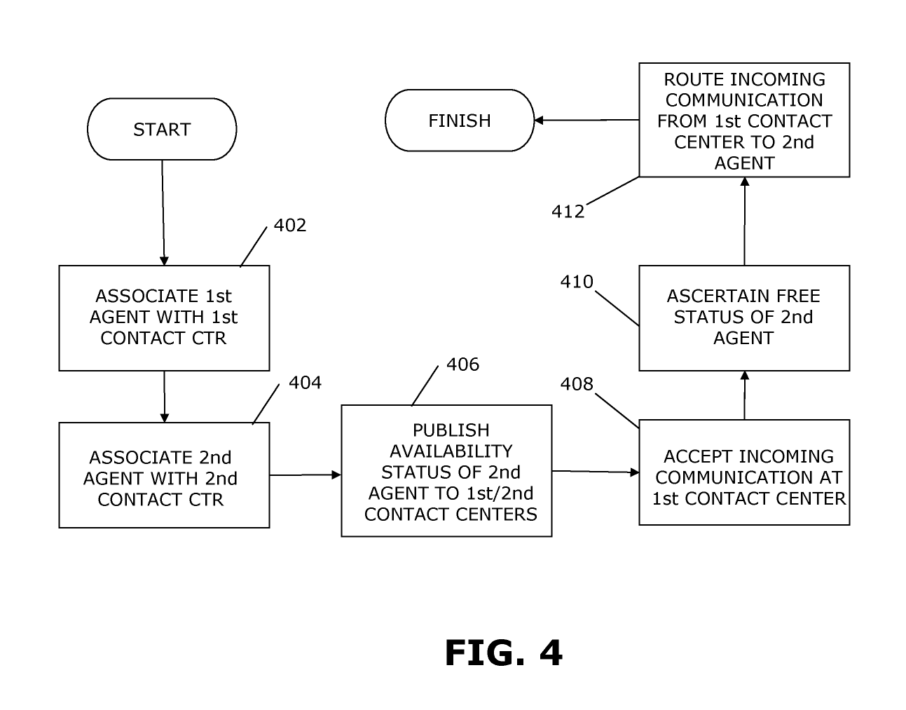

FIG. 4 sets forth a process more generally for virtualizing human agents across multiple locations, in accordance with at least one embodiment of the invention. It should be appreciated that a process such as that broadly illustrated in FIG. 4 can be carried out on essentially any suitable computer system or set of computer systems, which may, by way of an illustrative and on-restrictive example, include a system such as that indicated at 12 in FIG. 1. In accordance with an example embodiment, most if not all of the process steps discussed with respect to FIG. 4 can be performed by way a processing unit or units and system memory such as those indicated, respectively, at 16 and 28 in FIG. 1.

As shown in FIG. 4, a first agent is associated with a first contact center (402) and a second agent is associated with a second contact center (404). An availability status of the second agent is published, both to the first contact center and to the second contact center (406). An incoming communication is accepted at the first contact center (408) and a free status of the second agent is ascertained (410). The incoming communication is routed from the first contact center to the second agent (412).

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
associating a first agent with a first contact center;
associating a second agent with a second contact center;
publishing availability status of the second agent;
said publishing comprising publishing an availability status of the second agent both to the first contact center and to the second contact center;
accepting an incoming communication at the first contact center;
ascertaining a free status of the second agent; and
routing the incoming communication from the first contact center to the second agent.

2. The method according to claim 1, wherein said publishing comprises publishing an availability status of the second agent to a presence server at the first contact center.

3. The method according to claim 2, wherein:
said associating of the second agent comprises associating the second agent with a presence client; and
said publishing comprises employing the presence client to publish an availability status of the second agent to the presence server at the first contact center.

4. The method according to claim 2, wherein said publishing further comprises publishing an availability status of the second agent to a presence server at the second contact center.

5. The method according to claim 4, further comprising publishing an availability status of the second agent simultaneously to the presence server at the first contact center and the presence server at the second contact center simultaneously via employing separate SIP URI's corresponding to each presence server.

6. The method according to claim 5, wherein said simultaneous publishing comprises employing a multi-headed presence client.

7. The method according to claim 1, further comprising publishing an availability status of the first agent to the first contact center.

8. The method according to claim 7, further comprising publishing an availability status of the first agent to the second contact center.

9. The method according to claim 7, wherein:
said publishing of an availability status of the second agent comprises publishing to a presence server at the first contact center; and
said publishing of an availability status of the first agent comprises publishing to the presence server at the first contact center.

10. The method according to claim 9, wherein said publishing of availability status of the second agent further comprises to a presence server at the second contact center.

11. The method according to claim 1, further comprising publishing an updated availability status of the second agent to the first contact center.

12. The method according to claim 11, wherein said publishing of an updated availability status comprises publishing an updated availability status of the second agent to the first contact center responsive to routing of the incoming communication to the second agent.

13. The method according to claim 11, wherein said publishing of an updated availability status comprises publishing a busy status of the second agent to the first contact center.

14. The method according to claim 11, wherein:
said publishing of an availability status of the second agent comprises publishing to a presence server at the first contact center; and
said publishing of an updated availability status comprises publishing to the presence server at the first contact center.

15. The method according to claim 14, wherein:
said publishing of an availability status of the second agent comprises publishing to a presence server at the second contact center; and
said publishing of an updated availability status comprises publishing to the presence server at the second contact center.

16. The method according to claim 11, further comprising publishing a free status of the second agent to the first contact center responsive to a terminated condition of the incoming communication.

17. The method according to claim 1, wherein said accepting comprises accepting at least one taken from the group consisting of: an incoming telephone call and an incoming web-chat.

18. An apparatus comprising:
at least one processor; and
a computer readable storage medium having computer readable program code embodied therewith and executable by the at least one processor, the computer readable program code comprising:
computer readable program code configured to associate a first agent with a first contact center;
computer readable program code configured to associate a second agent with a second contact center;
computer readable program code configured to publish availability status of the second agent both to the first contact center and to the second contact center;
computer readable program code configured to accept an incoming communication at the first contact center;
computer readable program code configured to ascertain a free status of the second agent; and
computer readable program code configured to route the incoming communication from the first contact center to the second agent.

19. A computer program product comprising:
a computer readable storage medium having computer readable program code embodied therewith, the computer readable program code comprising:
computer readable program code configured to associate a first agent with a first contact center;
computer readable program code configured to associate a second agent with a second contact center;
computer readable program code configured to publish availability status of the second agent both to the first contact center and to the second contact center;
computer readable program code configured to accept an incoming communication at the first contact center;
computer readable program code configured to ascertain a free status of the second agent; and
computer readable program code configured to route the incoming communication from the first contact center to the second agent.

20. The method according to claim 19, wherein said computer readable program code is configured to publish an availability status of the second agent to a presence server at the first contact center.

21. The method according to claim 19, wherein said computer readable program code is further configured to publish an availability status of the first agent to the first contact center.

22. The method according to claim 21, wherein said computer readable program code is configured to publish an availability status of the first agent to a presence server at the first contact center.

23. The method according to claim 19, wherein said computer readable program code is further configured to publish an updated availability status of the second agent to the first contact center.

24. The method according to claim 23, wherein said computer readable program code is configured to publish an updated availability status of the second agent to the first contact center responsive to routing of the incoming communication to the second agent.

25. The method according to claim 23, wherein said computer readable program code is configured to:
publish an availability status of the second agent to a presence server at the first contact center; and
publish an updated availability status of the second agent to the presence server at the first contact center.
